(19) United States
(12) Patent Application Publication
(10) Pub. No.: US 2006/0085114 A1
(43) Pub. Date: Apr. 20, 2006

(54) Method for driving a retaining system

(76) Inventors: Michael Roelleke, Leonberg-Hoefingen (DE); Sabine Aust, Stuttgart (DE); Anja Czaykowska, Fellbach (DE)

Correspondence Address: KENYON & KENYON LLP, ONE BROADWAY, NEW YORK, NY, 10004, US

(21) Appl. No.: 10/518,165

(22) PCT Filed: Feb. 14, 2003
(86) PCT No.: PCT/DE03/00453

§ 371 Date: Aug. 4, 2005

(30) Foreign Application Priority Data
Jun. 18, 2002 (DE) 102 27 003.1

(51) Int. Cl. B60R 22/00

(52) U.S. Cl. 701/45; 701/46

(57) ABSTRACT

A method for triggering a restraint system is provided, in which the threshold value calculation, performed by using the acceleration signal, is adapted by an add-on amount which is determined from signal properties of the acceleration signal and the speed signal. Signals from an up-front sensor can be taken into account in addition.

### FIELD OF THE INVENTION

The present invention relates to a method for triggering a restraint system.

### SUMMARY OF THE INVENTION

In the method of the present invention for triggering a restraint system, the threshold value is adapted to the current situation, which is manifested by signal characteristics, by using a combined variable. This variable is determined from a plurality of characteristics of the acceleration signal and/or of the speed signal and/or of a further sensor signal. Thus the threshold value may be adapted to individual signal properties, and as a result of the combination of the various functions which examine these signal properties, only a single variable is employed and is used for adapting the threshold value. The result is a structured intervention into the method of the invention and thus into the tripping algorithm of the invention. This facilitates the intervention into the algorithm and makes for greater clarity. The various individual functions that examine the signal properties are combined using a predetermined logic and then intervene in the algorithm at only one point. Because of the influence at a single point, the requirement for variation for each signal at every instant can also be formulated, and thus a principle for new functionalities can be worked out more systematically. As a result, less time is expended for automatic parameter optimization.

It is especially advantageous that the characteristics are determined as a function of various functions for misuse detection, barrier detection, and crash type detection. The chronological conditions pertaining to the crash window, that is, the time when the tripping algorithm begins calculating, are also used for forming characteristics. All the characteristics may be combined in an adder, at the output of which an amplifier for assessing the variable is advantageously located. This amplifier may be adjusted as a function of certain signal properties. The acceleration signal which is used for the threshold value calculation may advantageously be filtered beforehand using one or more filters, such as a low-pass filter.

In another aspect of the present invention, some freely selectable characteristics derived from the acceleration signals, as well as optionally still other sensor signals such as from a passenger sensor system and/or a belt lock, are linked logically together in a matrix, so on the basis of the linkage a decision may be made whether these signals are relevant for the adaptation of the threshold value. Status variables and dynamic variables, in particular, may be linked together. Consequently, dynamic crash characteristics may be assessed, taking the status information into account that is input at the onset of a crash. This assessment may vary between unimportant and important, depending on the sensor signal in question, the vehicle, or the particular restraint device. “Important” or unimportant” here means a corresponding amplification factor; the more important the dynamic crash characteristic is, the higher the amplification factor and thus the greater the influence on the adaptation of the threshold value. The individual amplification factors are then combined via the entire matrix to form a total amplification factor for adapting the threshold value. The matrix concept makes it simple to add or delete new linkages. This considerably enhances the overall clarity.

It is especially advantageous to use a control unit for performing the method of the present invention for triggering a restraint system.

### BRIEF DESCRIPTION OF THE DRAWINGS

FIG. 1 shows an exemplary block diagram of the method of the present invention.

FIG. 2 shows an example of a signal pattern.

### DETAILED DESCRIPTION

In tripping algorithms, the acceleration signal and the integrated acceleration signal are typically processed independently of one another. Under some circumstances, the signal patterns of the acceleration signal and of the speed signal have characteristics that lead to an intervention into the tripping algorithm, in order to take the effect of these characteristics into account. For example, in the event of a hammer blow, which has an acceleration signal of brief duration but high amplitude, the threshold value is increased sharply, to avert tripping in response to such a hammer blow. An add-on amount in the tripping algorithm is then used for that purpose. A plurality of such characteristics in the signals may be detected by signal analysis, and according to the present invention are now added in an adder to make a variable which may be additionally assessed with an amplification factor. The method of the present invention permits a structural change in the algorithm of a kind that leads to a considerable simplification of intervention into the algorithm and in particular improves clarity.

Because of the stringent demands for very early signal discrimination using the algorithm, a basic concept which provides for the use of the acceleration signal on the one hand for calculating the threshold value for the speed signal and on the other is determined from the acceleration signal by integration, is reinforced with further functions. Particularly with the increased use of customer-specific functions, only local solutions to these problems are typically achieved. According to the present invention, these solutions are now combined systematically and in structured form. In particular, the overall intervention is scaled in the process. This averts multiplication of the basic algorithm concept, since it is unnecessary to have more than one independent tripping threshold.

In addition, by the described linkage of such status variables as the driver's seat position, the passengers' belt status, or the intrinsic vehicle speed at the onset of the crash with such dynamic variables as defined frequency components of the evaluation of the acceleration signal in the transverse vehicle direction, of the calculated crash severity from the acceleration signal of satellite sensors, or of vehicle-specific functions for detecting certain characteristics in crashes or misuse maneuvers, improved assessment of the dynamic variables during the course of a crash and hence better-adapted protection of the vehicle's passengers are achieved. That is, there is a fusion of sensor values in a matrix.

The following matrix illustrates a first example:

| | M1 | Belted | Unbelted |
|---|---|---|---|
| Y Severity | 1 | Minimal effect on belt | No effect |
| | | tightener threshold | |
| | 2 | Maximal effect on belt | No effect |
| | | tightener threshold | |
| | 3 | No effect | No effect |

The matrix describes the fact that in the course of the crash, increased acceleration values in the transverse vehicle direction (Y direction) are detected, which support the conclusion of an angled or offset crash. This Y severity, in Classes 1-3 (column M1), is combined, at the moment of detection, with the information about the belt status, that is, belted or unbelted. In the unbelted situation, the Y severity would be irrelevant for calculating the belt tightener threshold, while in the belted situation, the Y severity would predict a lateral motion of the passenger, and this motion could, for instance, influence a two-stage belt tightener system. In that case, the combined information is accordingly assessed as important, that is, of maximal effect. “Irrelevant” means there is no effect. A certain effect is indicated by the word “minimal”. This is then recalculated into a corresponding adaptation of the threshold value for the belt tightener.

The following matrix illustrates a second example:

| | | Driver | | Front-seat passenger | |
|---|---|---|---|---|---|
| | | Seat | Seat | Seat | Seat |
| M2 | M3 | Close | Far | Close | Far |
| Low | 1 | Maximal | None | Maximal | None |
| | 2 | Minimal | None | None | None |
| High | 1 | Maximal | Maximal | Maximal | Maximal |
| | 2 | Maximal | None | None | None |

In first column M2, high and low speeds are entered in the second and fourth lines. In second column M3, two frequency classes are then associated with these two speed stages. This first frequency class stands for a soft barrier, and the second frequency class stands for a hard barrier. In the third column, the effect that occurs for a forward driver's seat position is shown for that frequency class. In the fourth column, the effect when a driver's seat is positioned far back is shown. In the fifth and sixth columns, this is repeated for the front-seat passenger.

In the course of a crash, certain frequency components in the acceleration signal are detected that indicate a soft barrier. For them, the frequency components are put into classifications 1 and 2. At the moment the frequency components are detected, the frequency class is combined with the seat position information (relatively far forward or back) and the intrinsic speed at the onset of the crash. Since separate tripping thresholds for the driver and the front-seat passenger are calculated in the tripping algorithm, it is possible, depending on the calculated frequency class of the crash, to exert a varying influence on the tripping for a driver seated very far forward and a front-seat passenger seated very far back; the combination with the forward-seated passenger could be assessed as very important, and the combination with the rearward-seated passenger could be assessed as less important.

If a relatively low speed in combination with a driver seated very far forward is now detected, then the two-stage front air bag tripping could be desensitized because of the excessive risk of injury, while at a high speed, the front airbag is tripped earlier for a passenger seated farther forward than for a passenger seated farther back.

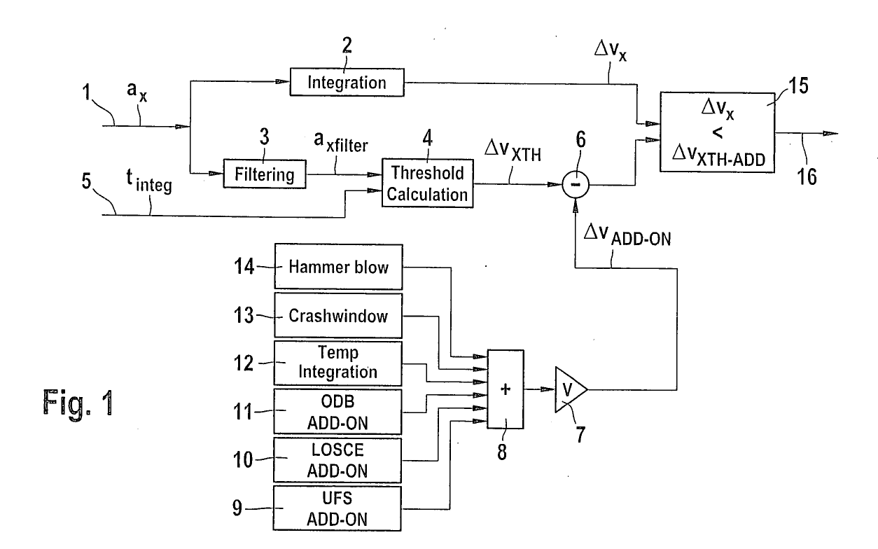

FIG. 1, in a block diagram, shows the method of the present invention for triggering a restraint system. An acceleration signal aₓ is input at point 1 in the block diagram. This acceleration signal is generated here in the control unit by an acceleration sensor or a combination of acceleration sensors disposed at angles to one another.

Alternatively or in addition, it is possible for the acceleration signal to be generated by a remote sensor or so-called satellite sensor. A satellite sensor of this kind may be disposed in the side and/or at the front of the vehicle.

Typically, micromechanical acceleration sensors that function piezoelectrically are used as sensors. However, mechanical sensors or other sensors that are suitable for picking up the acceleration are also possible. The acceleration signal is then used in two independent paths, on the one hand by an integration 2 for calculating a speed ΔVₓ and on the other for calculating a threshold value 4.

Before threshold-value calculation 4, filtering 3 of acceleration signal aₓ is performed. Typically, a low-pass filter is used as the filter. Signal a_{xfilter} is then present and enters into the calculation of the acceleration signal. An integration time 5 is used as a further input parameter into threshold-value calculation 4.

Threshold value ΔV_{XTH} thus determined is adapted by a subtractor 6 using correction value ΔV_{ADD-ON}. Correction value ΔV_{ADD-ON} has been generated by an amplifier 7. Amplifier 7 has amplified a signal from an adder 8. That is, it has performed weighting.

A plurality of characteristics or functions 9-14 are connected to the inputs of adder 8. These include the signal from an up-front sensor 9, an add-on amount for a deformable barrier 11, taking integration window 13 during the collision into account, and further taking hammer blow 14 into account. All these signal characteristics, which are derived from acceleration signal aₓ or integration signal ΔVₓ, are examined by these functions for their significance in view of varying the threshold value. It is possible for the individual functions to be weighted by their own amplification factors, and this weighting may be signal-dependent.

The adapted threshold value downstream of subtractor 6 then leads to a comparison, in a comparator 15, of threshold value ΔV_{XTH-ADD} with integrated acceleration signal ΔVₓ. As a function of this comparison, the restraint device is then triggered via an output 16. In other words, if signal ΔVₓ is above the threshold value, then a tripping situation is detected, and optionally as a function of plausibility, the restraint device, that is, a belt tightener or an air bag, may be triggered.

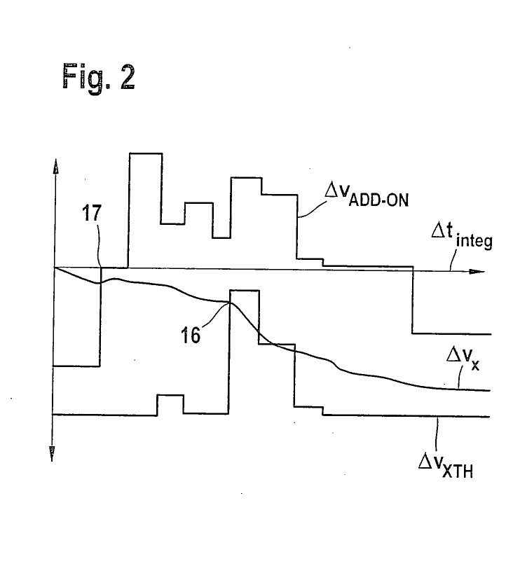

FIG. 2 shows the course of the threshold values with and without correction and the course of the integrated acceleration signal. It can be seen that integrated acceleration signal ΔVₓ up to time 17 is higher than both adapted threshold value ΔV_{XADD-ON} and threshold value ΔV_{XTH} that is output by threshold-value calculation 4. From this time 17 onward, however, the integrated acceleration signal is below the corrected threshold value, so that comparator 15 does not output any triggering signal for the restraint system. Without the correction by subtractor 6, integrated acceleration signal ΔVₓ would be above threshold value ΔV_{XTH} until time 16. It has thus been shown that tripping could be avoided by the signal analysis.

Alternatively, it is possible to use a system with a criterion that is compared with a fixed threshold. This threshold may then be varied by additional criteria. This makes it possible to replace a combination of individual criteria.

1-10. (canceled)

11. A method for triggering a restraint system, comprising:
generating an acceleration signal that characterizes a collision;
integrating the acceleration signal to form a speed signal;
determining a threshold value for the speed signal based on the acceleration signal, the threshold value being adapted by a first variable that is determined from at least one of a plurality of characteristics of the acceleration signal, the speed signal and at least one further sensor signal; and
triggering the restraint system as a function of a comparison of the speed signal with the threshold value.

12. The method of claim 11, wherein the plurality of characteristics of the acceleration signal are determined as a function of at least one of a hammer blow, an integration window, a signal from an up-front sensor, a signal variation caused by a deformable barrier, and a pattern detection.

13. The method of claim 11, further comprising:
combining the plurality of characteristics by addition.

14. The method of claim 11, wherein at least one amplifier is used to assess the first variable.

15. The method of claim 14, wherein the at least one amplifier is adjusted adaptively.

16. The method of claim 11, further comprising filtering the acceleration signal before determining the threshold value.

17. The method of claim 11, wherein the first variable is determined by logically linking at least two of the plurality of characteristics.

18. The method of claim 11, wherein the first variable is determined by logically linking at least one of the plurality of characteristics and the at least one sensor signal.

19. The method of claim 17, wherein the linking is performed using a logic matrix.

20. The method of claim 18, wherein the linking is performed using a logic matrix.

21. The method of claim 19, wherein both dynamic and static characteristics are linked in the matrix.

22. An apparatus for triggering a restraint system, comprising:
an arrangement for generating an acceleration signal that characterizes a collision;
an arrangement for integrating the acceleration signal to form a speed signal;
an arrangement for determining a threshold value for the speed signal based on the acceleration signal, the threshold value being adapted by a first variable that is determined from at least one of a plurality of characteristics of the acceleration signal, the speed signal and at least one further sensor signal; and
an arrangement for triggering the restraint system as a function of a comparison of the speed signal with the threshold value.

23. The apparatus as recited in claim 22, wherein the plurality of characteristics of the acceleration signal are determined as a function of at least one of a hammer blow, an integration window, a signal from an up-front sensor, a signal variation caused by a deformable barrier, and a pattern detection.
